(19) United States
(12) Patent Application Publication
(10) Pub. No.: US 2009/0114290 A1
(43) Pub. Date: May 7, 2009

(54) CO2 SUPPLY SYSTEM

(75) Inventors: Sheng-Chung YANG, Kaohsiung (TW); Kuo-Cheng LEE, Kaohsiung (TW); Ya-Shun CHENG, Kaohsiung (TW); Juan-Hong HONG, Kaohsiung (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: METAL INDUSTRIES RESEARCH & DEVELOPMENT CENTRE, Kaohsiung (TW)

(21) Appl. No.: 11/959,647

(22) Filed: Dec. 19, 2007

(30) Foreign Application Priority Data
Nov. 2, 2007 (TW) 096141429

(51) Int. Cl. F15B 1/00

(52) U.S. Cl. 137/340; 137/571

(57) ABSTRACT

The present invention relates to a CO₂ supply system. A condensing container is used to transform gas state CO₂ from a gas state CO₂ supply source into liquid CO₂. Therefore, a liquid CO₂ with stable pressure and stable flow rate could be provided (for example, supplied to a nozzle module to produce a great quantity of solid state CO₂ and gas state CO₂). Whereby, the usage of CO₂ can be reduced, so that the greenhouse effect can be alleviated and the manufacturing cost can be decreased.

### BACKGROUND OF THE INVENTION

1. Field of the Invention

The present invention relates to a CO₂ supply system, and more particularly to a CO₂ supply system capable of causing phase change of CO₂.

2. Description of the Related Art

FIG. 1 is a schematic view of a conventional liquid CO₂ supply device. The conventional liquid CO₂ supply device 1 has one CO₂ steel bottle 11, liquid CO₂ 12, and a delivery pipe 13. The CO₂ steel bottle 11 accommodates the liquid CO₂ 12. The CO₂ steel bottle 11 has an output port 111. One end of the delivery pipe 13 is connected to the output port 111, and the other end is immersed in the liquid CO₂ 12. The liquid CO₂ 12 is driven by the pressure inside the CO₂ steel bottle 11 to pass through the delivery pipe 13 and be output through the output port 111 for use.

However, when the liquid CO₂ 12 in the CO₂ steel bottle 11 is to be used out, the amount of the gas state CO₂ transformed from the liquid CO₂ 12 in the CO₂ steel bottle 11 is insufficient, thus the pressure inside the CO₂ steel bottle 11 is unstable. Or, it cannot be found that the liquid CO₂ 12 has been used out until the liquid level of the liquid CO₂ 12 is lower than the delivery pipe 13, so the replacement of the liquid CO₂ supply device 1 is delayed. Therefore, the gas state CO₂ transformed from the liquid CO₂ 12 in the CO₂ steel bottle 11 directly passes through the delivery pipe 13 and is output through the output port 111, which influences the supply operation of the liquid CO₂ 12.

As the conventional liquid CO₂ supply device 1 has the problem of unstable pressure, the replacement of the liquid CO₂ supply device 1 is delayed, leading to the waste of CO₂ and the increased usage of CO₂. Thus, the manufacturing cost is increased and the greenhouse effect is aggravated.

Consequently, there is an existing need for providing a CO₂ supply system to solve the above-mentioned problems.

### SUMMARY OF THE INVENTION

The present invention is directed to a CO₂ supply system, which comprises a condensing container and a gas state CO₂ supply source. The condensing container has an accommodation space. The gas state CO₂ supply source is connected to the accommodation space, and the gas state CO₂ is transformed into liquid CO₂ in the accommodation space.

The condensing container of the present invention transforms the gas state CO₂ into the liquid CO₂ and ensures the liquid state of the CO₂ accommodated in the accommodation space of the condensing container. Thus, the liquid CO₂ with stable pressure and stable flow rate could be provided to a nozzle module to produce a great quantity of the solid state and the gas state CO₂ through the nozzle module, for providing the protection of metal/alloy melt during casting. Whereby, the usage of CO₂ is reduced, so that the greenhouse effect is alleviated and the manufacturing cost is decreased.

### BRIEF DESCRIPTION OF THE DRAWINGS

FIG. 1 is a schematic view of a conventional liquid CO₂ supply device;

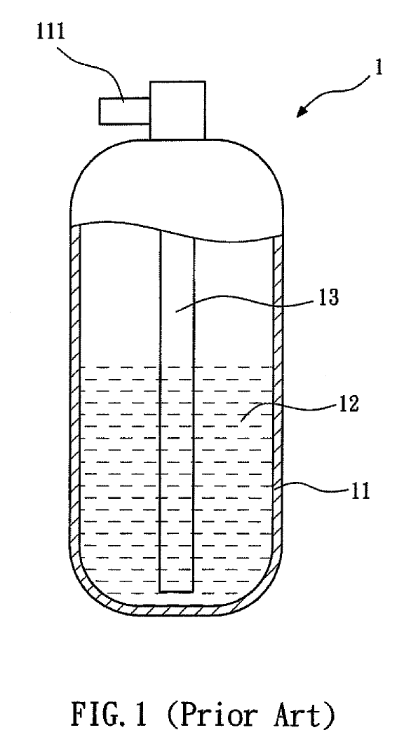

FIG. 2 is a schematic view of a CO₂ supply system according to a first embodiment of the present invention;

FIG. 3 is a schematic view of a CO₂ supply system according to a second embodiment of the present invention; and

FIG. 4 is a schematic view of the application of the CO₂ supply system according to the first embodiment of the present invention and the CO₂ supply system according to the second embodiment of the present invention in a metal/alloy melting process.

### DETAILED DESCRIPTION OF THE INVENTION

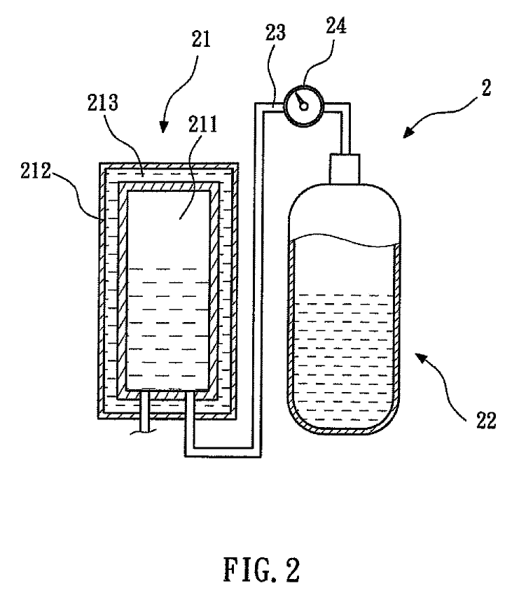

Referring to FIG. 2, a schematic view of a CO₂ supply system according to a first embodiment of the present invention is shown. The CO₂ supply system 2 of the first embodiment comprises a condensing container 21 and a gas state CO₂ supply source 22. The condensing container 21 has an accommodation space 211. In this embodiment, the condensing container 21 comprises a housing 212 and a cooling substance 213. The housing 212 encapsulates the accommodation space 211. The cooling substance 213 is disposed between the housing 212 and the accommodation space 211. The cooling substance 213 can be recycled repeatedly. Preferably, the cooling substance 213 is water.

The gas state CO₂ supply source 22 is connected to the accommodation space 211, and the gas state CO₂ is transformed into the liquid CO₂ in the accommodation space 211. Preferably, the gas state CO₂ supply source 22 is a CO₂ steel bottle or a CO₂ storage tank. In this embodiment, the CO₂ supply system 2 of the first embodiment further comprises a first connecting unit 23 that connects the condensing container 21 and the gas state CO₂ supply source 22. Preferably, the first connecting unit 23 is a high-pressure conduit. Further, the CO₂ supply system 2 of the first embodiment can further comprise a pressure sensing unit 24 disposed between the condensing container 21 and the gas state CO₂ supply source 22. The pressure sensing unit 24 senses the pressure of the gas state CO₂ supply source 22 and is respectively connected to the condensing container 21 and the gas state CO₂ supply source 22 through the first connecting unit 23.

The condensing container 21 of the present invention transforms the gas state CO₂ into the liquid CO₂ and ensures the liquid state of the CO₂ accommodated in the accommodation space 211 of the condensing container 21, thereby providing a liquid CO₂ with stable pressure and stable flow rate. Further, the pressure of the gas state CO₂ supply source 22 can be sensed by the pressure sensing unit 24 (i.e., the usage of gas state CO₂), so as to serve as a basis of replacing the gas state CO₂ supply source 22.

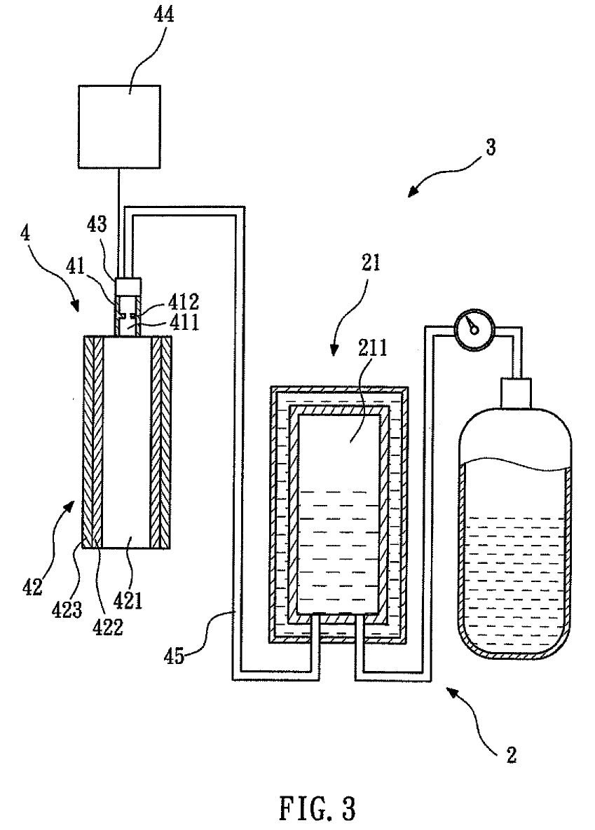

Referring to FIG. 3, a schematic view of a CO₂ supply system according to a second embodiment of the present invention is shown. Referring to FIGS. 2 and 3, the CO₂ supply system 3 of the second embodiment comprises the CO₂ supply system 2 of the first embodiment and a nozzle module 4. The CO₂ supply system 2 of the first embodiment has been described in detail in the first embodiment and the description will not be repeated herein.

The nozzle module 4 is connected to the CO₂ supply system 2 of the first embodiment. The nozzle module 4 comprises a jet unit 41 and a heat isolation unit 42. The jet unit 41 is connected to the accommodation space 211 and has a first channel 411. The heat isolation unit 42 is connected to the jet unit 41 and has a second channel 421. The second channel 421 is communicated with the first channel 411. Preferably, the size of the second channel 421 is greater than that of the first channel 411.

In this embodiment, the heat isolation unit 42 comprises a heat isolation material 422 and a heat insulating material 423. The heat insulating material 423 is disposed on the outer surface of the heat isolation material 422. Preferably, the heat isolation material 422 is a TEFLON material, and the heat insulating material 423 is a foam material. When liquid CO₂ enters the second channel 421 through the first channel 411 of the jet unit 41, the liquid CO₂ is transformed into the solid state CO₂ and the gas state CO₂.

In this embodiment, the jet unit 41 has an orifice structure 412 (for example, an orifice plate) disposed in the first channel 411. Preferably, the size of the orifice of the orifice structure 412 is 0.03 mm² to 0.4 mm².

Preferably, the nozzle module 4 can further comprise an electromagnetic valve 43 disposed between the jet unit 41 and the condensing container 21, for controlling the liquid CO₂ entering or not entering the jet unit 41. Further, the nozzle module 4 can further comprise a control device 44 electrically connected to the electromagnetic valve 43, for adjusting and controlling the flow rate of the liquid CO₂ getting into the jet unit 41. In this embodiment, the condensing container 21 and the electromagnetic valve 43 are connected by a second connecting unit 45, and in other applications, the condensing container 21, the electromagnetic valve 43, and the jet unit 41 are connected by the second connecting unit 45. Preferably, the second connecting unit 45 is a high-pressure conduit.

The condensing container 21 of the present invention transforms the gas state CO₂ into the liquid CO₂ and ensures the liquid state of the CO₂ accommodated in the condensing container 21, thereby providing the liquid CO₂ with stable pressure and stable flow rate. By adjusting and controlling the flow rate of liquid CO₂ with stable pressure and stable flow rate provided by the CO₂ supply system 2 of the first embodiment entering the jet unit 41 by the control device 44, the liquid CO₂ is then jetted into the second channel 421, so as to produce a great quantity of solid state CO₂ and gas state CO₂. Whereby, the usage of CO₂ is reduced, so that the greenhouse effect is alleviated and the manufacturing cost is decreased.

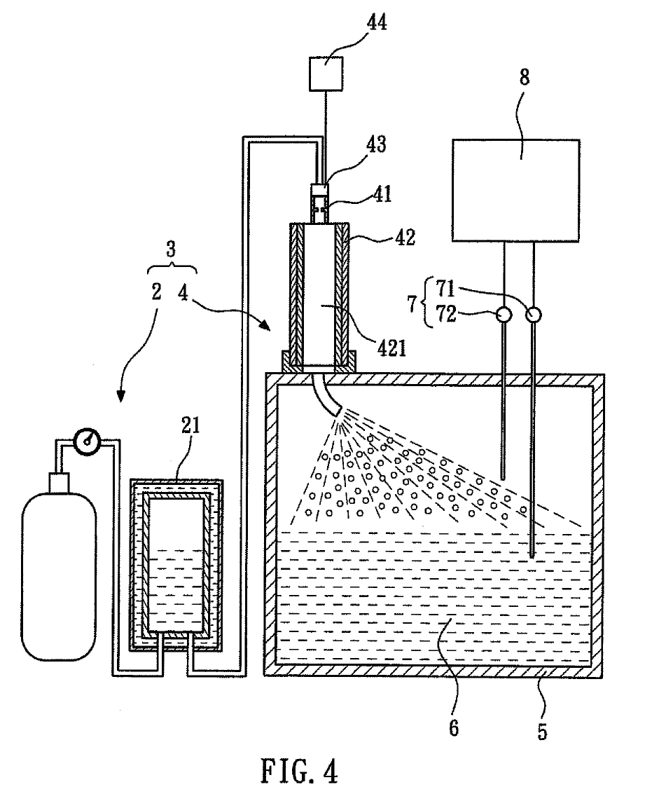

FIG. 4 is a schematic view of the application of the CO₂ supply system 3 according to the second embodiment of the present invention in a metal/alloy melting process. It is noted that the CO₂ supply system 3 according to the second embodiment of the present invention is not limited to be applied in the field of metal/alloy melting, but can also be applied in any other fields requiring CO₂.

Referring to FIGS. 2 to 4, in this embodiment, the CO₂ supply system 3 of the second embodiment is connected to a melting furnace 5, for protecting the metal/alloy melt. The CO₂ supply system 3 of the second embodiment is connected to the melting furnace 5 by the heat isolation unit 42 of the nozzle module 4. The melting furnace 5 accommodates a metal/alloy melt 6 (for example, magnesium alloy).

The condensing container 21 of the CO₂ supply system 2 of the first embodiment transforms the gas state CO₂ into the liquid CO₂ and provides the liquid CO₂ with stable pressure and stable flow rate to the nozzle module 4. The jet unit 41 of the nozzle module 4 then jets liquid CO₂ with stable pressure and stable flow rate into the second channel 421 to produce a great quantity of solid state and gas state CO₂. The solid state CO₂ and gas state CO₂ are sprayed into the melting furnace 5 through the second channel 421, for protecting the metal/alloy melt 6. The solid state CO₂ upon contacting the surface of the high-temperature metal/alloy melt 6 is sublimated into gas, so as to reduce the surface temperature of the metal/alloy melt 6 by the use of the quick heat absorption capability (573 KJ/kg), and to decrease the oxidation rate of the metal/alloy melt 6.

In this embodiment, a thermocouple 7 can further penetrate in the melting furnace. Preferably, the thermocouple 7 is connected to a data processing device 8 (for example, a computer). The thermocouple 7 comprises a first thermocouple 71 and a second thermocouple 72. The first thermocouple 71 contacts the metal/alloy melt 6, and the second thermocouple 72 is located above the metal/alloy melt 6 and does not contact the metal/alloy melt 6, for measuring the temperature of the metal/alloy melt 6 and the temperature of the gas inside the melting furnace 5 respectively.

It is noted that directed to the protection conditions required for melting the metal/alloy, the spraying amount of the solid state CO₂ and gas state CO₂ can be adjusted (for example, continuously spraying the solid state CO₂ and gas state CO₂, or discontinuously spraying solid state CO₂ and gas state CO₂ by means of pulses), so as to quickly reduce the concentration of oxygen gas in the melting furnace 5, and isolate the metal/alloy melt 6 from the air, so as to prevent the metal/alloy melt 6 from combusting and achieve the purpose of protection.

Further, the nozzle module 4 is connected to the melting furnace 5 through the heat isolation unit 42, so the high temperature caused by the melting furnace 5 will not be conducted to the nozzle module 4, and thus the efficiency of the nozzle module 4 producing the solid state CO₂ and gas state CO₂ will not be reduced. Additionally, the control device 44 could be used to adjust and control the flow rate of liquid CO₂ entering the jet unit 41, thus reducing the usage of CO₂, so that the greenhouse effect is alleviated and the manufacturing cost is decreased.

While the embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

What is claimed is:

1. A CO₂ supply system, comprising:
a condensing container, having an accommodation space; and
a gas state CO₂ supply source, connected to the accommodation space, wherein the gas state CO₂ is transformed into liquid CO₂ in the accommodation space.

2. The CO₂ supply system according to claim 1, wherein the condensing container further comprises a housing and a cooling substance, the housing encapsulates the accommodation space, and the cooling substance is disposed between the housing and the accommodation space.

3. The CO₂ supply system according to claim 2, wherein the cooling substance is water.

4. The CO₂ supply system according to claim 1, wherein the gas state CO₂ supply source is a CO₂ steel bottle or a CO₂ storage tank.

5. The CO₂ supply system according to claim 1, further comprising a pressure sensing unit disposed between the condensing container and the gas state CO₂ supply source.

6. The CO₂ supply system according to claim 1, further comprising a first connecting unit that connects the condensing container and the gas state CO₂ supply source.

7. The CO₂ supply system according to claim 6, wherein the first connecting unit is a high-pressure conduit.

8. The CO₂ supply system according to claim 1, further comprising a nozzle module connected to the condensing container.

9. The CO₂ supply system according to claim 8, wherein the nozzle module comprises:
a jet unit, connected to the accommodation space, and having a first channel; and
a heat isolation unit, connected to the jet unit, and having a second channel, wherein the second channel is communicated with the first channel, and the size of the second channel is greater than that of the first channel;
wherein the liquid CO₂ enters the second channel through the first channel, such that the liquid CO₂ is transformed into solid state CO₂ and gas state CO₂.

10. The CO₂ supply system according to claim 9, wherein the jet unit has an orifice structure disposed in the first channel.

11. The CO₂ supply system according to claim 10, wherein the orifice structure is an orifice plate.

12. The CO₂ supply system according to claim 11, wherein the size of the orifice of the orifice structure is 0.03 mm² to 0.4 m².

13. The CO₂ supply system according to claim 9, wherein the nozzle module further comprises an electromagnetic valve disposed between the jet unit and the condensing container.

14. The CO₂ supply system according to claim 13, wherein the nozzle module further comprises a control device electrically connected to the electromagnetic valve.

15. The CO₂ supply system according to claim 14, further comprising a second connecting unit that connects the condensing container, the electromagnetic valve, and the control device.

16. The CO₂ supply system according to claim 15, wherein the second connecting unit is a high-pressure conduit.

17. The CO₂ supply system according to claim 9, wherein the heat isolation unit comprises a heat isolation material and a heat insulating material, wherein the heat insulating material is disposed on an outer surface of the heat isolation material.

18. The CO₂ supply system according to claim 17, wherein the heat isolation material is a TEFLON material.

19. The CO₂ supply system according to claim 17, wherein the heat insulating material is a foam material.
